(19) United States
(12) Patent Application Publication
(10) Pub. No.: US 2017/0032669 A1
(43) Pub. Date: Feb. 2, 2017

(54) APPARATUS AND METHOD FOR CONTROLLING TRAFFIC LIGHTS OF A CROSSING

(71) Applicant: FUJITSU LIMITED, Kawasaki-shi (JP)

(72) Inventors: Jianrong WU, Beijing (CN); Zhiming TAN, Beijing (CN); Qi WANG, Beijing (CN); Akihiro HIGASHI, Beijing (CN)

(73) Assignee: FUJITSU LIMITED, Kawasaki-shi (JP)

(21) Appl. No.: 15/223,538

(22) Filed: Jul. 29, 2016

(30) Foreign Application Priority Data
Jul. 31, 2015 (CN) 201510463079.6

(51) Int. Cl. G08G 1/08; G06K 9/00

(52) U.S. Cl. CPC G08G 1/08; G06K 9/00785

(57) ABSTRACT

An apparatus and method for controlling traffic lights of a crossing where the traffic lights are controlled based on the jam states of the roads and according to jam levels of the roads, weights of the roads and the number of vehicles passing the crossing, which are fast in response and accurate in estimation, and the traffic lights can be quickly and efficiently controlled, thereby efficiently alleviating or solving the problem of traffic jam.

### CROSS-REFERENCE TO RELATED APPLICATIONS

This application claims the priority benefit of Chinese Patent Application No. 201510463079.6, filed on Jul. 31, 2015 in the Chinese State Intellectual Property Office, the disclosure of which is incorporated herein in its entirety by reference.

### BACKGROUND

1. Field

The present disclosure relates to the field of information technologies, and in particular to an apparatus and method for controlling traffic lights of a crossing.

2. Description of the Related Art

As the development of cities and the improvement of living standard, the number of vehicles is increasing year by year, and the problem of traffic jam is also increasingly outstanding. Hence, monitoring of road traffic states and reasonable control of crossing traffic lights are one of important means for solving the problem of traffic jam.

In an existing method, the traffic jam states are usually estimated based on a single method of car counting, to control the traffic lights.

It should be noted that the above description of the background is merely provided for clear and complete explanation of the present disclosure and for easy understanding by those skilled in the art. And it should not be understood that the above technical solution is known to those skilled in the art as it is described in the background of the present disclosure.

### SUMMARY

Additional aspects and/or advantages will be set forth in part in the description which follows and, in part, will be apparent from the description, or may be learned by practice of the embodiments.

When the above existing method is used to estimate a traffic jam state and control traffic lights, an estimation result will be inaccurate and a response time is relatively long, and the traffic lights cannot be quickly and efficiently controlled, hence, the problem of traffic jam cannot be efficiently alleviated or solved.

Embodiments of the present disclosure provide an apparatus and method for controlling traffic lights of a crossing, which control traffic lights based on the jam states of the roads and according to jam levels of the roads, weights of the roads and the number of vehicles passing the crossing, and are fast in response and accurate in estimation, and are able to quickly and efficiently control the traffic lights, thereby efficiently alleviating or solving the problem of traffic jam.

According to a first aspect of the embodiments of the present disclosure, there is provided an apparatus for controlling traffic lights of a crossing, a road of a first direction and a road of a second direction intersecting at the crossing, the apparatus including: a detecting unit configured to detect jam states of the road of the first direction and the road of the second direction for predefined regions in monitoring images of the road of the first direction and the road of the second direction; a counting unit configured to respectively count vehicles on the road of the first direction and the road of the second direction passing the crossing in the predefined regions within a predefined period of time; and a controlling unit configured to control traffic lights of the road of the first direction and the road of the second direction based on the jam states of the road of the first direction and the road of the second direction and according to jam levels of the road of the first direction and the road of the second direction, weights of the road of the first direction and the road of the second direction and the number of the vehicles on the road of the first direction and the road of the second direction passing the crossing within the predefined period of time.

According to a second aspect of the embodiments of the present disclosure, there is provided a method for controlling traffic lights of a crossing, a road of a first direction and a road of a second direction intersecting at the crossing, the method including: detecting jam states of the road of the first direction and the road of the second direction for predefined regions in monitoring images of the road of the first direction and the road of the second direction; counting respectively vehicles on the road of the first direction and the road of the second direction passing the crossing in the predefined regions within a predefined period of time; and controlling traffic lights of the road of the first direction and the road of the second direction based on the jam states of the road of the first direction and the road of the second direction and according to jam levels of the road of the first direction and the road of the second direction, weights of the road of the first direction and the road of the second direction and the number of the vehicles on the road of the first direction and the road of the second direction passing the crossing within the predefined period of time.

An advantage of the embodiments of the present disclosure exists in that the traffic lights are controlled based on the jam states of the roads and according to jam levels of the roads, weights of the roads and the number of vehicles passing the crossing, which are fast in response and accurate in estimation, and the traffic lights can be quickly and efficiently controlled, thereby efficiently alleviating or solving the problem of traffic jam.

With reference to the following description and drawings, the particular embodiments of the present disclosure are disclosed in detail, and the principles of the present disclosure and the manners of use are indicated. It should be understood that the scope of embodiments of the present disclosure is not limited thereto. Embodiments of the present disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

The drawings are included to provide further understanding of the present disclosure, which constitute a part of the specification and illustrate the exemplary embodiments of the present disclosure, and are used for setting forth the principles of the present disclosure together with the description. It is clear and understood that the accompanying drawings in the following description are some embodiments of the present disclosure only, and a person of ordinary skill in the art may obtain other accompanying drawings according to these accompanying drawings without making an inventive effort. In the drawings:

FIG. 1 is a schematic diagram of a structure of the apparatus for controlling traffic lights of a crossing of Embodiment 1 of the present disclosure;

FIG. 2 is a schematic diagram of ROIs of a road of a first direction and a road of a second direction of Embodiment 1 of the present disclosure;

FIG. 3 is a schematic diagram of obtaining the ROI of Embodiment 1 of the present disclosure;

FIG. 4 is a schematic diagram of a structure of the detecting unit 101 of Embodiment 1 of the present disclosure;

FIG. 5 is a flowchart of a method for detecting jam states of the road of a first direction and the road of a second direction of Embodiment 1 of the present disclosure;

FIG. 6 is a schematic diagram of obtaining contour images of Embodiment 1 of the present disclosure;

FIG. 7 is a schematic diagram of a structure of the controlling unit 103 of Embodiment 1 of the present disclosure;

FIG. 8 is a schematic diagram of a structure of the first controlling unit 701 of Embodiment 1 of the present disclosure;

FIG. 9 is a schematic diagram of a structure of the third controlling unit 703 of Embodiment 1 of the present disclosure;

FIG. 10 is a schematic diagram of a structure of the electronic equipment of Embodiment 2 of the present disclosure;

FIG. 11 is a block diagram of a systematic structure of the electronic equipment of Embodiment 2 of the present disclosure;

FIG. 12 is a flowchart of the method for controlling traffic lights of a crossing of Embodiment 3 of the present disclosure; and

FIG. 13 is a flowchart of the method for controlling traffic lights of a crossing of Embodiment 4 of the present disclosure.

### DETAILED DESCRIPTION

Reference will now be made in detail to the embodiments, examples of which are illustrated in the accompanying drawings, wherein like reference numerals refer to the like elements throughout. The embodiments are described below by referring to the figures.

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

### Embodiment 1

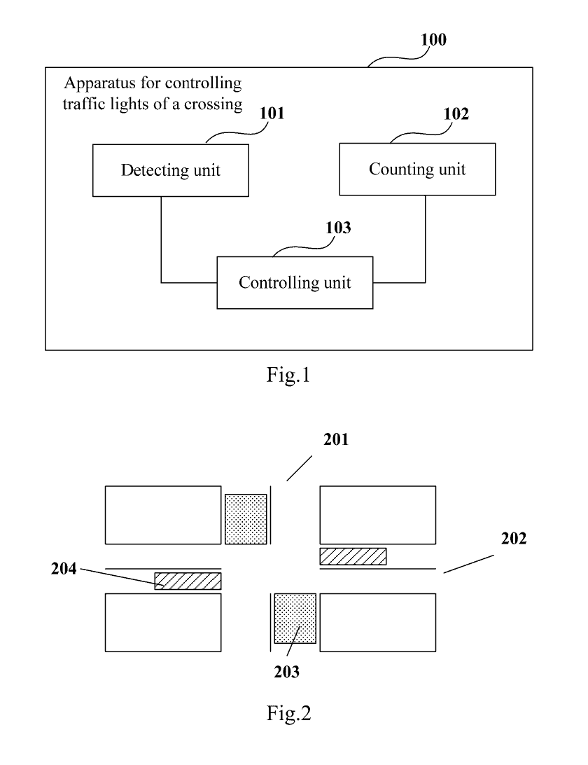

FIG. 1 is a schematic diagram of a structure of the apparatus for controlling traffic lights of a crossing of Embodiment 1 of the present disclosure, a road of a first direction and a road of a second direction intersecting at the crossing. As shown in FIG. 1, the apparatus 100 includes:
a detecting unit 101 configured to detect jam states of the road of the first direction and the road of the second direction for predefined regions in monitoring images of the road of the first direction and the road of the second direction;
a counting unit 102 configured to respectively count vehicles on the road of the first direction and the road of the second direction passing the crossing in the predefined regions within a predefined period of time; and
a controlling unit 103 configured to control traffic lights of the road of the first direction and the road of the second direction based on the jam states of the road of the first direction and the road of the second direction and according to jam levels of the road of the first direction and the road of the second direction, weights of the road of the first direction and the road of the second direction and the number of the vehicles on the road of the first direction and the road of the second direction passing the crossing within the predefined period of time.

It can be seen from the above embodiment that the traffic lights are controlled based on the jam states of the roads and according to jam levels of the roads, weights of the roads and the number of vehicles passing the crossing, which are fast in response and accurate in estimation, and the traffic lights can be quickly and efficiently controlled, thereby efficiently alleviating or solving the problem of traffic jam.

In this embodiment, the road of the first direction and the road of the second direction intersect at the crossing. In this embodiment, the road of the first direction and the road of the second direction may intersect at any angle. For example, the road of the first direction and the road of the second direction vertically intersect at the crossing.

In this embodiment, the monitoring images of the road of the first direction and the road of the second direction may be obtained by using an existing method. For example, the monitoring images may be obtained by extracting a frame of image in a monitoring video, and the monitoring video may be obtained by a camera mounted over the crossing.

In this embodiment, the traffic lights at the crossing include traffic lights controlling the road of the first direction and traffic lights controlling the road of the second direction. For example, the traffic lights may be green lights and red lights.

In this embodiment, the predefined regions in the monitoring images of the road of the first direction and the road of the second direction may be set according to an actual situation. For example, the predefined regions may be regions of interest (ROIs).

FIG. 2 is a schematic diagram of ROIs of the road of the first direction and the road of the second direction of Embodiment 1 of the present disclosure. As shown in FIG. 2, 201 denotes the road of the first direction, 202 denotes the road of the second direction, 203 denotes an ROI in the monitoring image of the road of the first direction, and 204 denotes an ROI in the monitoring image of the road of the second direction.

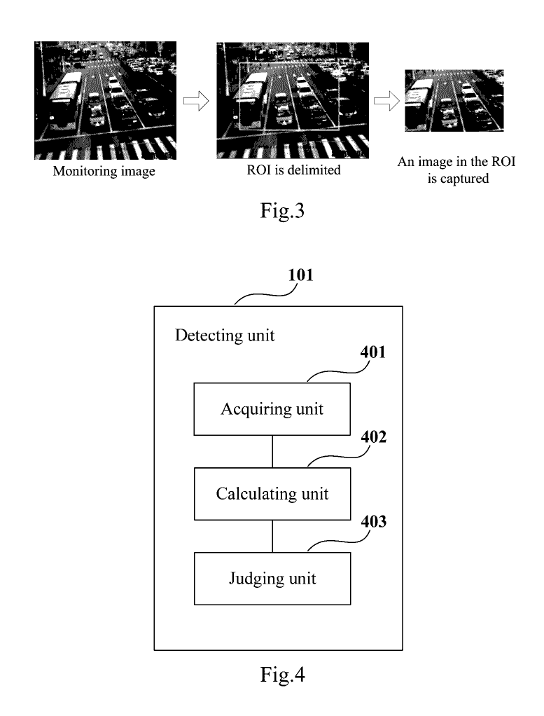

FIG. 3 is a schematic diagram of obtaining the ROI of Embodiment 1 of the present disclosure. As shown in FIG. 3, the ROI is delimited in a monitoring image, and an image in the ROI is captured from the monitoring image.

In this embodiment, the jam state refers to “whether it is jammed”. For example, the jam state of the road of the first direction is jammed, and the jam state of the road of the second direction is being not jammed.

In this embodiment, the detecting unit 101 detects the jam states of the road of the first direction and the road of the second direction for the predefined regions in the monitoring images of the road of the first direction and the road of the second direction. A structure of the detecting unit 101 and a method for detecting the jam states of the road of the first direction and the road of the second direction shall be illustrated below.

FIG. 4 is a schematic diagram of a structure of the detecting unit 101 of Embodiment 1 of the present disclosure. As shown in FIG. 4, the detecting unit 101 includes:
an acquiring unit 401 configured to respectively obtain contour images of the predefined regions of the road of the first direction and the road of the second direction;
a calculating unit 402 configured to respectively calculate contour occupation ratios of the contour images of the road of the first direction and the road of the second direction; and
a judging unit 403 configured to respectively judge the jam states of the road of the first direction and the road of the second direction according to the contour occupation ratios of the road of the first direction and the road of the second direction. For example, it is judged as being jammed when the contour occupation ratios are greater than or equal to a predefined threshold value, and it is judged as being not jammed when the contour occupation ratios are less than the predefined threshold value.

FIG. 5 is a flowchart of the method for detecting jam states of the road of a first direction and the road of a second direction of Embodiment 1 of the present disclosure. As shown in FIG. 5, the method includes:
Step 501: contour images of the predefined regions of the road of the first direction and the road of the second direction are obtained respectively;
Step 502: contour occupation ratios of the contour images of the road of the first direction and the road of the second direction are calculated respectively; and
Step 503: the jam states of the road of the first direction and the road of the second direction are judged respectively according to the contour occupation ratios of the road of the first direction and the road of the second direction. For example, it is judged as being jammed when the contour occupation ratios are greater than or equal to a predefined threshold value, and it is judged as being not jammed when the contour occupation ratios are less than the predefined threshold value.

In this way, the jam states of the roads are judged by the contour occupation ratios, with a judgment result being relatively accurate.

In this embodiment, the acquiring unit 401 may respectively obtain the contour images of the predefined regions of the road of the first direction and the road of the second direction by using an existing method. A method of obtaining the contour images of Embodiment 1 of the present disclosure shall be illustrated below.

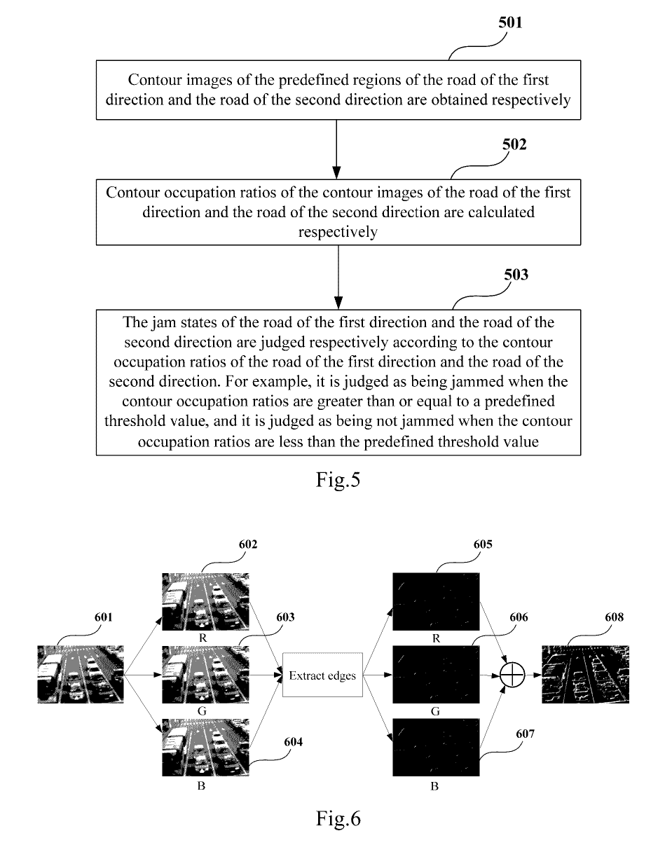

FIG. 6 is a schematic diagram of obtaining the contour images of Embodiment 1 of the present disclosure. As shown in FIG. 6, a color image 601 of a predefined region is decomposed into images 602-604 of R, G, B components. An edge extraction method is used to extract edges of the images 602-604 of the R, G, B components, to obtain edge detection images 605-607 of the R, G, B components, and the edge detection images 605-607 of the R, G, B components are combined, to obtain a contour image 608 of the predefined region.

In this embodiment, for a case where the monitoring images are gray scale images, the edge extraction method may be directly used to obtain the edge detection images, and the edge detection images may be taken as the contour images.

In this embodiment, the calculating unit 402 may calculate the contour occupation ratios ratioOccup according to Formula (1):

$$ratioOccup = \frac{numCon}{width ROI \cdot height ROI} ; \qquad ( 1 )$$

where, numCon denotes the number of contour pixels in the contour images, and widthROI and heightROI respectively denote a width and a height of the predefined region, that is, the number of pixels in a width direction and the number of pixels in a height direction.

In this embodiment, the judging unit 403 respectively judges the jam states of the road of the first direction and the road of the second direction according to the contour occupation ratios of the road of the first direction and the road of the second direction. For example, it is judged as being jammed when the contour occupation ratios are greater than or equal to the predefined threshold value, and it is judged as being not jammed when the contour occupation ratios are less than the predefined threshold value.

In this embodiment, the predefined threshold value may be set according to an actual situation. For example, the predefined threshold value may be 0.4 or 0.5.

In this embodiment, the counting unit 102 respectively counts vehicles on the road of the first direction and the road of the second direction passing the crossing in the predefined regions within the predefined period of time. For example, an existing method may be used for counting.

In this embodiment, the predefined period of time may be set according to an actual situation. For example, the predefined period of time may be five minutes earlier than a current time, or a period of time between 14:00 and 14:30.

In this embodiment, after the detecting unit 101 detects the jam states of the road of the first direction and the road of the second direction and the counting unit 102 counts vehicles on the road of the first direction and the road of the second direction passing the crossing, the controlling unit 103 controls the traffic lights of the road of the first direction and the road of the second direction based on the jam states of the road of the first direction and the road of the second direction and according to jam levels of the road of the first direction and the road of the second direction, weights of the road of the first direction and the road of the second direction and the number of the vehicles on the road of the first direction and the road of the second direction passing the crossing within the predefined period of time.

In this embodiment, the jam levels of the road of the first direction and the road of the second direction may be calculated by using an existing method. For example, the jam levels may be expressed by contour occupation ratios, and the contour occupation ratios may be calculated by using Formula (1) above, which shall not be described herein any further.

In this embodiment, the weights of the road of the first direction and the road of the second direction may be set according to an actual situation. For example, the weights of the road of the first direction and the road of the second direction may be set according to whether a road is a trunk road and the number of lanes.

A structure of the controlling unit 103 and a method for controlling the traffic lights shall be illustrated below.

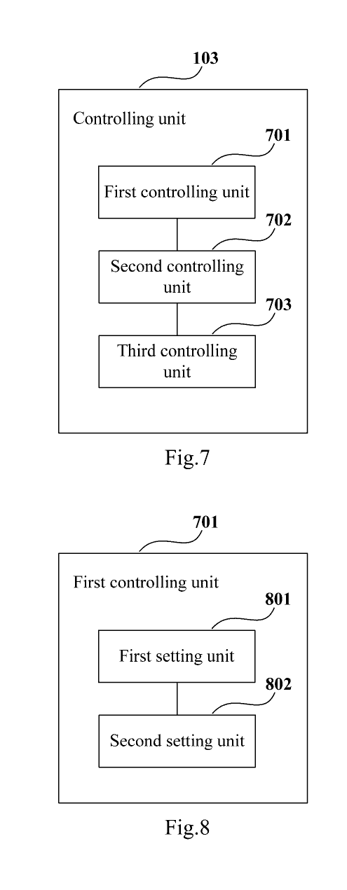

FIG. 7 is a schematic diagram of the structure of the controlling unit 103 of Embodiment 1 of the present disclosure. As shown in FIG. 7, the controlling unit 103 includes:
a first controlling unit 701 configured to, when both of the jam states of the road of the first direction and the road of the second direction are jammed, set duration of green lights of the road of the first direction and the road of the second direction according to a relationship between a product of the jam level of the road of the first direction and the weight of the road of the first direction and a product of the jam level of the road of the second direction and the weight of the road of the second direction;
a second controlling unit 702 configured to, when only one of the jam states of the road of the first direction and the road of the second direction is jammed, set the duration of the green light of the jammed road to be greater than the duration of the green light of the unjammed road; and
a third controlling unit 703 configured to, when neither of the jam states of the road of the first direction and the road of the second direction is jammed, set the duration of the green lights of the road of the first direction and the road of the second direction according to the jam levels of the road of the first direction and the road of the second direction, the weights of the road of the first direction and the road of the second direction, the number of the vehicles on the road of the first direction and the road of the second direction passing the crossing within the predefined period of time, a weight of the jam level and a weight of the number of the vehicles passing the crossing.

In this embodiment, the controlling unit 103 may include at least one of the first controlling unit 701, the second controlling unit 702 and the third controlling unit 703.

In this embodiment, the first controlling unit 701 controls the traffic lights in a case where both the jam states of the road of the first direction and the road of the second direction are jammed. FIG. 8 is a schematic diagram of a structure of the first controlling unit 701 of Embodiment 1 of the present disclosure. As shown in FIG. 8, the first controlling unit 701 includes:
a first setting unit 801 configured to set the duration of the green light of the road of the first direction to be greater than the duration of the green light of the road of the second direction when the product of the jam level of the road of the first direction and the weight of the road of the first direction is greater than the product of the jam level of the road of the second direction and the weight of the road of the second direction; and
a second setting unit 802 configured to set the duration of the green light of the road of the first direction to be less than the duration of the green light of the road of the second direction when the product of the jam level of the road of the first direction and the weight of the road of the first direction is less than the product of the jam level of the road of the second direction and the weight of the road of the second direction.

In this embodiment, when the product of the jam level of the road of the first direction and the weight of the road of the first direction is equal to the product of the jam level of the road of the second direction and the weight of the road of the second direction, it shows that the duration of the traffic lights at this moment is reasonable, control is not needed and original duration of the traffic lights is maintained.

In this embodiment, the duration of the green lights may be expressed by occupation ratios of the green lights. For example, a sum of an occupation ratio of the duration of the green light of the road of the first direction and an occupation ratio of the duration of the green light of the road of the second direction is 1.

In this embodiment, the first setting unit 801 is configured to set the duration of the green light of the road of the first direction to be greater than the duration of the green light of the road of the second direction when the product of the jam level of the road of the first direction and the weight of the road of the first direction is greater than the product of the jam level of the road of the second direction and the weight of the road of the second direction. For example, the respective occupation ratios of the duration of the green lights may be set according to an actual situation. For example, the occupation ratio of the duration of the green light of the road of the first direction is set to be 55%, and the occupation ratio of the duration of the green light of the road of the second direction is set to be 45%.

In this embodiment, the second setting unit 802 is configured to set the duration of the green light of the road of the first direction to be less than the duration of the green light of the road of the second direction when the product of the jam level of the road of the first direction and the weight of the road of the first direction is less than the product of the jam level of the road of the second direction and the weight of the road of the second direction. For example, the respective occupation ratios of the duration of the green lights may be set according to an actual situation. For example, the occupation ratio of the duration of the green light of the road of the first direction is set to be 45%, and the occupation ratio of the duration of the green light of the road of the second direction is set to be 55%.

In this embodiment, the second controlling unit 702 controls the traffic lights in a case where only one of the jam states of the road of the first direction and the road of the second direction is jammed. For example, the second controlling unit 702 is configured to, when only one of the jam states of the road of the first direction and the road of the second direction is jammed, set the duration of the green light of the jammed road to be greater than the duration of the green light of the unjammed road.

For example, when the road of the first direction is jammed and the road of the second direction is unjammed, the duration of the green light of the road of the first direction is set to be greater than the duration of the green light of the road of the second direction, and the respective occupation rations of the duration of the green lights may be set according to an actual situation. For example, the occupation ratio of the duration of the green light of the road of the first direction is set to be 65%, and the occupation ratio of the duration of the green light of the road of the second direction is set to be 35%.

And when the road of the first direction is unjammed and the road of the second direction is jammed, the duration of the green light of the road of the first direction is set to be less than the duration of the green light of the road of the second direction, and the respective occupation rations of the duration of the green lights may be set according to an actual situation. For example, the occupation ratio of the duration of the green light of the road of the first direction is set to be 35%, and the occupation ratio of the duration of the green light of the road of the second direction is set to be 65%.

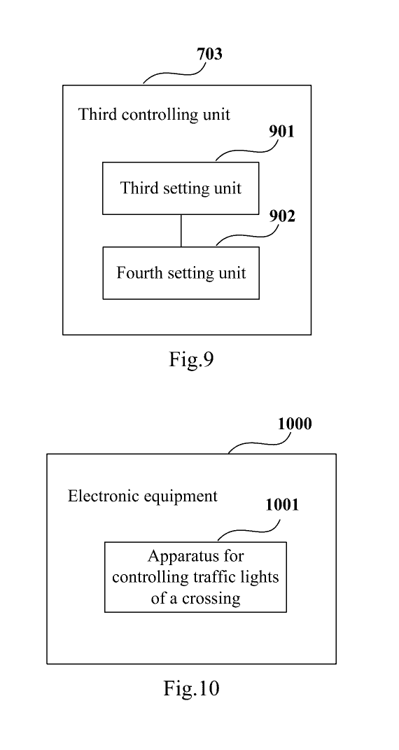

In this embodiment, the third controlling unit 703 controls the traffic lights in a case where both the jam states of the road of the first direction and the road of the second direction are not jammed. FIG. 9 is a schematic diagram of a structure of the third controlling unit 703 of Embodiment 1 of the present disclosure. As show in FIG. 9, the third controlling unit 703 includes:
a third setting unit 901 configured to set the duration of the green light of the road of the first direction to be greater than the duration of the green light of the road of the second direction when following formula (2) is satisfied; and
a fourth setting unit 902 configured to set the duration of the green light of the road of the first direction to be less than the duration of the green light of the road of the second direction when following formula (3) is satisfied;

weightD1·(jamRatioD1·weightJr+countD1·weightCt)>weightD2·(jamRatioD2·weightJr+countD2·weightCt) (2);

weightD1·(jamRatioD1·weightJr+countD1·weightCt)<weightD2·(jamRatioD2·weightJr+countD2·weightCt) (3);
where, weightD1 and weightD2 respectively denote the weights of the road of the first direction and the road of the second direction, jamRatioD1 and jamRatioD2 respectively denote the jam levels of the road of the first direction and the road of the second direction, countD1 and countD2 respectively denote the number of the vehicles on the road of the first direction and the road of the second direction passing the crossing within the predefined period of time, weightJr denotes the weight of the jam level, and weightCt denotes the weight of the number of the vehicles passing the crossing.

In this embodiment, when the former part and the latter part of formulae (2) and (3) are equal, it shows that the duration of the traffic lights at this moment is reasonable, control is not needed and original duration of the traffic lights is maintained.

In this embodiment, the third setting unit 901 is configured to set the duration of the green light of the road of the first direction to be greater than the duration of the green light of the road of the second direction when the above formula (2) is satisfied. Wherein, the respective occupation rations of the duration of the green lights may be set according to an actual situation. For example, the occupation ratio of the duration of the green light of the road of the first direction is set to be 55%, and the occupation ratio of the duration of the green light of the road of the second direction is set to be 45%.

In this embodiment, the fourth setting unit 902 is configured to set the duration of the green light of the road of the first direction to be less than the duration of the green light of the road of the second direction when the above formula (3) is satisfied. For example, the occupation ratio of the duration of the green light of the road of the first direction is set to be 45%, and the occupation ratio of the duration of the green light of the road of the second direction is set to be 55%.

In this embodiment, a sum of a weight of the jam level and a weight of the number of the vehicles passing the crossing is 1, and the weights of the jam level and the number of the vehicles passing the crossing may be set according to an actual situation.

For example, when it is more desired that the traffic lights are controlled according to a jam level, a weight of the jam level may be set to be a relatively large value, such as 0.7, and at this moment, a weight of the number of the vehicles passing the crossing is 0.3; and when it is desired that the traffic lights are controlled according to a jam level only, a weight of the jam level may be set to be 1, and at this moment, a weight of the number of the vehicles passing the crossing is 0.

On the contrary, when it is more desired that the traffic lights are controlled according to the number of the vehicles passing the crossing, a weight of the number of the vehicles passing the crossing may be set to be a relatively large value, such as 0.7, and at this moment, a weight of the jam level is 0.3; and when it is desired that the traffic lights are controlled according to the number of the vehicles passing the crossing only, a weight of the number of the vehicles passing the crossing may be set to be 1, and at this moment, a weight of the jam level is 0.

In this way, the weights of the factors on which controlling the traffic lights is based may be flexibly set according to an actual situation, and different control modes may be switched, thereby satisfying different application demands.

It can be seen from the above embodiment that the traffic lights are controlled based on the jam states of the roads and according to the jam levels of the roads, weights of the roads and the number of the vehicles passing the crossing, which are fast in response and accurate in estimation, and are able to quickly and efficiently control the traffic lights, thereby efficiently alleviating or solving the problem of traffic jam.

### Embodiment 2

An embodiment of the present disclosure further provides electronic equipment. FIG. 10 is a schematic diagram of a structure of the electronic equipment of Embodiment 2 of the present disclosure. As shown in FIG. 10, the electronic equipment 1000 includes an apparatus 1001 for controlling traffic lights of a crossing. In this embodiment, a structure and functions of the control apparatus 1001 of traffic lights of a crossing are identical to those described in Embodiment 1, and shall not be described herein any further.

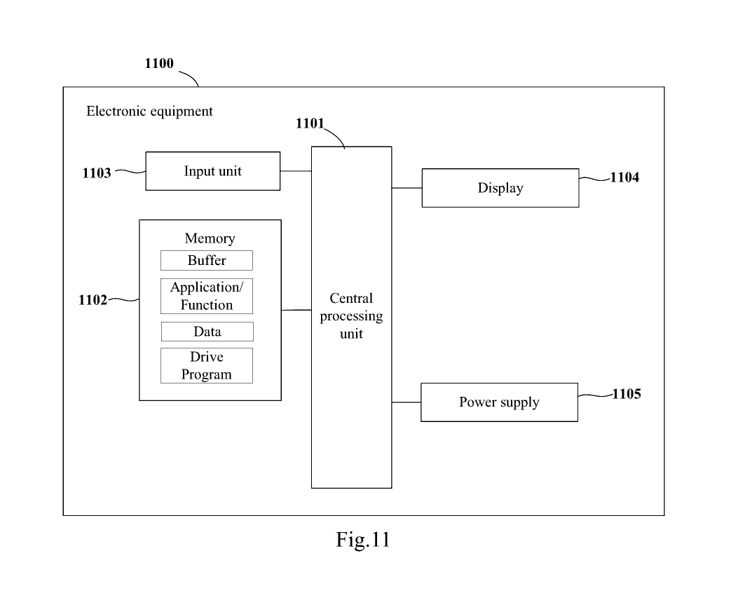

FIG. 11 is a block diagram of a systematic structure of the electronic equipment of Embodiment 2 of the present disclosure. As shown in FIG. 11, the electronic equipment 1100 may include a central processing unit 1101 and a memory 1102, the memory 1102 being coupled to the central processing unit 1101. This figure is illustrative only, and other types of structures may also be used, so as to supplement or replace this structure and achieve telecommunications function or other functions.

As shown in FIG. 11, the electronic equipment 1100 may further include an input unit 1103, a display 1104, and a power supply 1105.

In an implementation, the functions of the apparatus for controlling traffic lights of a crossing described in Embodiment 1 may be integrated into the central processing unit 1101. In this embodiment, the central processing unit 1101 may be configured to: detect jam states of the road of the first direction and the road of the second direction for predefined regions in monitoring images of the road of the first direction and the road of the second direction; respectively count vehicles on the road of the first direction and the road of the second direction passing the crossing in the predefined regions within a predefined period of time; and control traffic lights of the road of the first direction and the road of the second direction based on the jam states of the road of the first direction and the road of the second direction and according to jam levels of the road of the first direction and the road of the second direction, weights of the road of the first direction and the road of the second direction and the number of the vehicles on the road of the first direction and the road of the second direction passing the crossing within the predefined period of time.

In this embodiment, the detecting jam states of the road of the first direction and the road of the second direction for predefined regions in monitoring images of the road of the first direction and the road of the second direction includes: obtaining respectively contour images of the predefined regions of the road of the first direction and the road of the second direction; calculating respectively contour occupation ratios of the contour images of the road of the first direction and the road of the second direction; and judging respectively the jam states of the road of the first direction and the road of the second direction according to the contour occupation ratios of the road of the first direction and the road of the second direction; wherein, it is judged as being jammed when the contour occupation ratios are greater than or equal to a predefined threshold value, and it is judged as being not jammed when the contour occupation ratios are less than the predefined threshold value.

In this embodiment, the controlling traffic lights of the road of the first direction and the road of the second direction based on the jam states of the road of the first direction and the road of the second direction and according to jam levels of the road of the first direction and the road of the second direction, weights of the road of the first direction and the road of the second direction and the number of the vehicles on the road of the first direction and the road of the second direction passing the crossing within the predefined period of time includes: setting duration of green lights of the road of the first direction and the road of the second direction according to a relationship between a product of the jam level of the road of the first direction and the weight of the road of the first direction and a product of the jam level of the road of the second direction and the weight of the road of the second direction when both of the jam states of the road of the first direction and the road of the second direction are jammed.

In this embodiment, the setting duration of green lights of the road of the first direction and the road of the second direction according to a relationship between a product of the jam level of the road of the first direction and the weight of the road of the first direction and a product of the jam level of the road of the second direction and the weight of the road of the second direction when both of the jam states of the road of the first direction and the road of the second direction are jammed includes: setting the duration of the green light of the road of the first direction to be greater than the duration of the green light of the road of the second direction when the product of the jam level of the road of the first direction and the weight of the road of the first direction is greater than the product of the jam level of the road of the second direction and the weight of the road of the second direction; and setting the duration of the green light of the road of the first direction to be less than the duration of the green light of the road of the second direction when the product of the jam level of the road of the first direction and the weight of the road of the first direction is less than the product of the jam level of the road of the second direction and the weight of the road of the second direction.

In this embodiment, the controlling traffic lights of the road of the first direction and the road of the second direction based on the jam states of the road of the first direction and the road of the second direction and according to jam levels of the road of the first direction and the road of the second direction, weights of the road of the first direction and the road of the second direction and the number of the vehicles on the road of the first direction and the road of the second direction passing the crossing within the predefined period of time, includes: setting the duration of the green light of the jammed road to be greater than the duration of the green light of the unjammed road when only one of the jam states of the road of the first direction and the road of the second direction is jammed.

In this embodiment, the controlling traffic lights of the road of the first direction and the road of the second direction based on the jam states of the road of the first direction and the road of the second direction and according to jam levels of the road of the first direction and the road of the second direction, weights of the road of the first direction and the road of the second direction and the number of the vehicles on the road of the first direction and the road of the second direction passing the crossing within the predefined period of time, includes: setting the duration of the green lights of the road of the first direction and the road of the second direction according to the jam levels of the road of the first direction and the road of the second direction, the weights of the road of the first direction and the road of the second direction, the number of the vehicles on the road of the first direction and the road of the second direction passing the crossing within the predefined period of time, a weight of the jam level and a weight of the number of the vehicles passing the crossing, when neither of the jam states of the road of the first direction and the road of the second direction is jammed.

In another implementation, the apparatus for controlling traffic lights of a crossing described in Embodiment 1 and the central processing unit 1101 may be configured separately. For example, the apparatus for controlling traffic lights of a crossing may be configured as a chip connected to the central processing unit 1101, with its functions being realized under control of the central processing unit 1101.

In this embodiment, the electronic equipment 1100, or computer system, does not necessarily include all the parts shown in FIG. 11.

As shown in FIG. 11, the central processing unit 1101 is sometimes referred to as a controller or control, and may include a microprocessor or other processor devices and/or logic devices. The central processing unit 1101 receives input and controls operations of every components of the electronic equipment 1100.

The memory 1102 may be, for example, one or more of a buffer memory, a flash memory, a hard drive, a mobile medium, a volatile memory, a nonvolatile memory, or other suitable devices. And the central processing unit 1101 may execute the programs stored in the memory 1102, so as to realize information storage or processing, etc. Functions of other parts are similar to those of the prior art, which shall not be described herein any further. The parts of the electronic equipment 1100 may be realized by specific hardware, firmware, software, or any combination thereof, without departing from the scope of the present disclosure.

It can be seen from the above embodiment that the traffic lights are controlled based on the jam states of the roads and according to the jam levels of the roads, weights of the roads and the number of the vehicles passing the crossing, which are fast in response and accurate in estimation, and are able to quickly and efficiently control the traffic lights, thereby efficiently alleviating or solving the problem of traffic jam.

### Embodiment 3

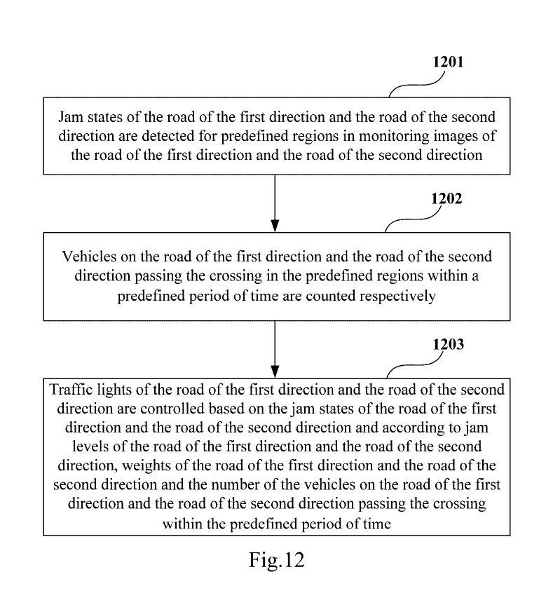

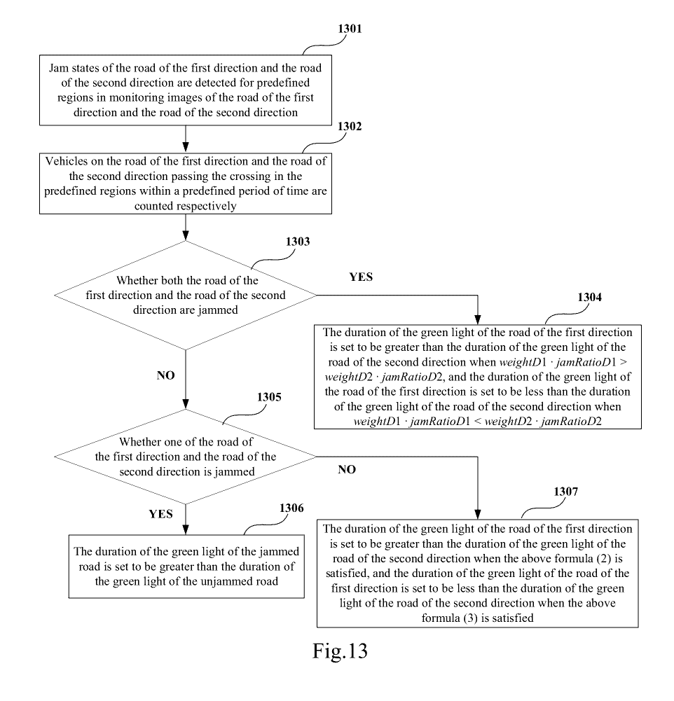

An embodiment of the present disclosure further provides a method for controlling traffic lights of a crossing, corresponding to the apparatus for controlling traffic lights of a crossing of Embodiment 1. FIG. 12 is a flowchart of the method for controlling traffic lights of a crossing of Embodiment 3 of the present disclosure. As shown in FIG. 12, the method includes:
Step 1201: jam states of the road of the first direction and the road of the second direction are detected for predefined regions in monitoring images of the road of the first direction and the road of the second direction;
Step 1202: vehicles on the road of the first direction and the road of the second direction passing the crossing in the predefined regions within a predefined period of time are counted respectively; and
Step 1203: traffic lights of the road of the first direction and the road of the second direction are controlled based on the jam states of the road of the first direction and the road of the second direction and according to jam levels of the road of the first direction and the road of the second direction, weights of the road of the first direction and the road of the second direction and the number of the vehicles on the road of the first direction and the road of the second direction passing the crossing within the predefined period of time.

In this embodiment, an order of executing steps 1201 and 1202 is not limited, and they may be executed in turn, and may also be executed simultaneously.

In this embodiment, a method for detecting jam states, a method for counting vehicles and a method for controlling traffic lights are identical to those described in Embodiment 1, and shall not be described herein any further.

It can be seen from the above embodiment that the traffic lights are controlled based on the jam states of the roads and according to the jam levels of the roads, weights of the roads and the number of the vehicles passing the crossing, which are fast in response and accurate in estimation, and are able to quickly and efficiently control the traffic lights, thereby efficiently alleviating or solving the problem of traffic jam.

### Embodiment 4

An embodiment of the present disclosure further provides a method for controlling traffic lights of a crossing, corresponding to the apparatus for controlling traffic lights of a crossing of Embodiment 1. FIG. 13 is a flowchart of the method for controlling traffic lights of a crossing of Embodiment 4 of the present disclosure. As shown in FIG. 13, the method includes:
Step 1301: jam states of the road of the first direction and the road of the second direction are detected for predefined regions in monitoring images of the road of the first direction and the road of the second direction;
Step 1302: vehicles on the road of the first direction and the road of the second direction passing the crossing in the predefined regions within a predefined period of time are counted respectively;
Step 1303: it is judged whether both the road of the first direction and the road of the second direction are jammed, entering into step 1304 when it is judged “yes”, and entering into step 1305 when it is judged “no”;
Step 1304: the duration of the green light of the road of the first direction is set to be greater than the duration of the green light of the road of the second direction when weightD1 jamRatioD1>weightD2·jamRatioD2, and the duration of the green light of the road of the first direction is set to be less than the duration of the green light of the road of the second direction when weightD1 jamRatioD1<weightD2·jamRatioD2. In this embodiment, weightD1 and weightD2 respectively denote the weights of the road of the first direction and the road of the second direction, and jamRatioD1 and jamRatioD2 respectively denote the jam levels of the road of the first direction and the road of the second direction;
Step 1305: it is judged whether one of the road of the first direction and the road of the second direction is jammed, entering into step 1306 when it is judged “yes”, and entering into step 1307 when it is judged “no”;
Step 1306: the duration of the green light of the jammed road is set to be greater than the duration of the green light of the unjammed road; and
Step 1307: the duration of the green light of the road of the first direction is set to be greater than the duration of the green light of the road of the second direction when the above formula (2) is satisfied, and the duration of the green light of the road of the first direction is set to be less than the duration of the green light of the road of the second direction when the above formula (3) is satisfied.

In this embodiment, an order of executing steps 1301 and 1302 is not limited, and they may be executed in turn, and may also be executed simultaneously.

In this embodiment, a method for detecting jam states, a method for counting vehicles and a method for controlling traffic lights are identical to those described in Embodiment 1, and shall not be described herein any further.

It can be seen from the above embodiment that the traffic lights are controlled based on the jam states of the roads and according to the jam levels of the roads, weights of the roads and the number of the vehicles passing the crossing, which are fast in response and accurate in estimation, and are able to quickly and efficiently control the traffic lights, thereby efficiently alleviating or solving the problem of traffic jam.

An embodiment of the present disclosure further provides a computer-readable program, when the program is executed in an apparatus for controlling traffic lights of a crossing or electronic equipment, the program enables the apparatus for controlling traffic lights of a crossing or the electronic equipment to carry out the method for controlling traffic lights of a crossing as described in Embodiment 3 or 4.

An embodiment of the present disclosure further provides a storage medium in which a computer-readable program is stored, the computer-readable program enables an apparatus for controlling traffic lights of a crossing or electronic equipment to carry out the method for controlling traffic lights of a crossing as described in Embodiment 3 or 4.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a non-transitory storage medium for storing the above program, such as a hard disk, a floppy disk, a CD, a DVD, and a flash memory, etc.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the principles of the present disclosure, and such variants and modifications fall within the scope of the present disclosure.

Although a few embodiments have been shown and described, it would be appreciated by those skilled in the art that changes may be made in these embodiments without departing from the principles and spirit of the embodiments, the scope of which is defined in the claims and their equivalents.

What is claimed is:

1. An apparatus for controlling traffic lights of a crossing, a road of a first direction and a road of a second direction intersecting at the crossing, the apparatus comprising:
a detecting unit configured to detect jam states of the road of the first direction and the road of the second direction for predefined regions in monitored images of the road of the first direction and the road of the second direction;
a counting unit configured to respectively count vehicles on the road of the first direction and the road of the second direction passing the crossing in the predefined regions within a predefined period of time; and
a controlling unit configured to control traffic lights of the road of the first direction and the road of the second direction based on the jam states of the road of the first direction and the road of the second direction and according to jam levels of the road of the first direction and the road of the second direction, weights assigned to the road of the first direction and the road of the second direction and a number of the vehicles on the road of the first direction and the road of the second direction passing the crossing within the predefined period of time.

2. The apparatus according to claim 1, wherein the detecting unit comprises:
an acquiring unit configured to respectively obtain contour images of the predefined regions of the road of the first direction and the road of the second direction;
a calculating unit configured to respectively calculate contour occupation ratios of the contour images of the road of the first direction and the road of the second direction; and
a judging unit configured to respectively judge the jam states of the road of the first direction and the road of the second direction according to the contour occupation ratios of the road of the first direction and the road of the second direction where it is judged as being jammed when the contour occupation ratios are greater than or equal to a predefined threshold value, and it is judged as being not jammed when the contour occupation ratios are less than the predefined threshold value.

3. The apparatus according to claim 1, wherein the controlling unit comprises: a first controlling unit configured to, when both of the jam states of the road of the first direction and the road of the second direction are jammed, set a duration of green lights of the road of the first direction and the road of the second direction according to a relationship between a product of a jam level of the road of the first direction and a weight of the road of the first direction and a product of the jam level of the road of the second direction and the weight of the road of the second direction.

4. The apparatus according to claim 3, wherein the first controlling unit comprises:
a first setting unit configured to set the duration of a green light of the road of the first direction to be greater than the duration of the green light of the road of the second direction when the product of the jam level of the road of the first direction and the weight of the road of the first direction is greater than the product of the jam level of the road of the second direction and the weight of the road of the second direction; and
a second setting unit configured to set the duration of the green light of the road of the first direction to be less than the duration of the green light of the road of the second direction when the product of the jam level of the road of the first direction and the weight of the road of the first direction is less than the product of the jam level of the road of the second direction and the weight of the road of the second direction.

5. The apparatus according to claim 4, wherein the controlling unit comprises:
a second controlling unit configured to, when only one of the jam states of the road of the first direction and the road of the second direction is jammed indicating an unjammed road, set the duration of the green light of the jammed road to be greater than the duration of the green light of the unjammed road.

6. The apparatus according to claim 5, wherein the controlling unit comprises:
a third controlling unit configured to, when neither of the jam states of the road of the first direction and the road of the second direction is jammed, set the duration of the green lights of the road of the first direction and the road of the second direction according to the jam levels of the road of the first direction and the road of the second direction, the weights of the road of the first direction and the road of the second direction, the number of the vehicles on the road of the first direction and the road of the second direction passing the crossing within the predefined period of time, a weight of the jam level and a weight of the number of the vehicles passing the crossing.

7. The apparatus according to claim 6, wherein the third controlling unit comprises:
a third setting unit configured to set the duration of the green light of the road of the first direction to be greater than the duration of the green light of the road of the second direction when formula (1) is satisfied; and
a fourth setting unit configured to set the duration of the green light of the road of the first direction to be less than the duration of the green light of the road of the second direction when formula (2) is satisfied;
weightD1·(jamRatioD1·weightJr+countD1·weightCt)>weightD2. (jamRatioD2·weightJr+countD2·weightCt) (1);
weightD1·(jamRatioD1·weightJr+countD1·weightCt)<weightD2·(jamRatioD2·weightJr+countD2·weightCt) (2);
where, weightD1 and weightD2 respectively denote the weights of the road of the first direction and the road of the second direction, jamRatioD1 and jamRatioD2 respectively denote the jam levels of the road of the first direction and the road of the second direction, countD1 and countD2 respectively denote the number of the vehicles on the road of the first direction and the road of the second direction passing the crossing within the predefined period of time, weightJr denotes the weight of the jam level, and weightCt denotes the weight of the number of the vehicles passing the crossing.

8. A method for controlling traffic lights of a crossing, a road of a first direction and a road of a second direction intersecting at the crossing, the method comprising:
detecting jam states of the road of the first direction and the road of the second direction for predefined regions in monitored images of the road of the first direction and the road of the second direction;
counting respectively vehicles on the road of the first direction and the road of the second direction passing the crossing in the predefined regions within a predefined period of time; and
controlling traffic lights of the road of the first direction and the road of the second direction based on the jam states of the road of the first direction and the road of the second direction and according to jam levels of the road of the first direction and the road of the second direction, weights of the road of the first direction and the road of the second direction and a number of the vehicles on the road of the first direction and the road of the second direction passing the crossing within the predefined period of time.

9. The method according to claim 8, wherein the detecting jam states of the road of the first direction and the road of the second direction for predefined regions in monitored images of the road of the first direction and the road of the second direction comprises:
obtaining respectively contour images of the predefined regions of the road of the first direction and the road of the second direction;
calculating respectively contour occupation ratios of the contour images of the road of the first direction and the road of the second direction; and
judging respectively the jam states of the road of the first direction and the road of the second direction according to the contour occupation ratios of the road of the first direction and the road of the second direction where it is judged as being jammed when the contour occupation ratios are greater than or equal to a predefined threshold value, and it is judged as being not jammed when the contour occupation ratios are less than the predefined threshold value.

10. The method according to claim 8, wherein the controlling traffic lights of the road of the first direction and the road of the second direction based on the jam states of the road of the first direction and the road of the second direction and according to jam levels of the road of the first direction and the road of the second direction, weights of the road of the first direction and the road of the second direction and the number of the vehicles on the road of the first direction and the road of the second direction passing the crossing within the predefined period of time comprises:
setting a duration of green lights of the road of the first direction and the road of the second direction according to a relationship between a product of a jam level of the road of the first direction and a weight of the road of the first direction and a product of the jam level of the road of the second direction and the weight of the road of the second direction, when both of the jam states of the road of the first direction and the road of the second direction are jammed.

11. The method according to claim 10, wherein the setting duration of the green lights of the road of the first direction and the road of the second direction according to a relationship between a product of the jam level of the road of the first direction and the weight of the road of the first direction and a product of the jam level of the road of the second direction and the weight of the road of the second direction when both of the jam states of the road of the first direction and the road of the second direction are jammed comprises:
setting the duration of the green light of the road of the first direction to be greater than the duration of the green light of the road of the second direction when the product of the jam level of the road of the first direction and the weight of the road of the first direction is greater than the product of the jam level of the road of the second direction and the weight of the road of the second direction; and
setting the duration of the green light of the road of the first direction to be less than the duration of the green light of the road of the second direction when the product of the jam level of the road of the first direction and the weight of the road of the first direction is less than the product of the jam level of the road of the second direction and the weight of the road of the second direction.

12. The method according to claim 11, wherein the controlling traffic lights of the road of the first direction and the road of the second direction based on the jam states of the road of the first direction and the road of the second direction and according to jam levels of the road of the first direction and the road of the second direction, weights of the road of the first direction and the road of the second direction and the number of the vehicles on the road of the first direction and the road of the second direction passing the crossing within the predefined period of time comprises:
setting the duration of the green light of a jammed road to be greater than the duration of the green light of an unjammed road when only one of the jam states of the road of the first direction and the road of the second direction is jammed.

13. The method according to claim 13, wherein the controlling traffic lights of the road of the first direction and the road of the second direction based on the jam states of the road of the first direction and the road of the second direction and according to jam levels of the road of the first direction and the road of the second direction, weights of the road of the first direction and the road of the second direction and the number of the vehicles on the road of the first direction and the road of the second direction passing the crossing within the predefined period of time comprises:
setting the duration of the green lights of the road of the first direction and the road of the second direction according to the jam levels of the road of the first direction and the road of the second direction, the weights of the road of the first direction and the road of the second direction, the number of the vehicles on the road of the first direction and the road of the second direction passing the crossing within the predefined period of time, a weight of the jam level and a weight of the number of the vehicles passing the crossing, when neither of the jam states of the road of the first direction and the road of the second direction is jammed.

14. The method according to claim 13, wherein the setting the duration of the green lights of the road of the first direction and the road of the second direction according to the jam levels of the road of the first direction and the road of the second direction, the weights of the road of the first direction and the road of the second direction, the number of the vehicles on the road of the first direction and the road of the second direction passing the crossing within the predefined period of time, a weight of the jam level and a weight of the number of the vehicles passing the crossing, when neither of the jam states of the road of the first direction and the road of the second direction is jammed comprises:
setting the duration of the green light of the road of the first direction to be greater than the duration of the green light of the road of the second direction when following formula (1) is satisfied; and
setting the duration of the green light of the road of the first direction to be less than the duration of the green light of the road of the second direction when following formula (2) is satisfied;
weightD1·(jamRatioD1·weightJr+countD1·weightCt)>weightD2·(jamRatioD2·weightJr+countD2·weightCt) (1);
weightD1·(jamRatioD1·weightJr+countD1·weightCt)<weightD2. (jamRatioD2·weightJr+countD2·weightCt) (2);
where, weightD1 and weightD2 respectively denote the weights of the road of the first direction and the road of the second direction, jamRatioD1 and jamRatioD2 respectively denote the jam levels of the road of the first direction and the road of the second direction, countD1 and countD2 respectively denote the number of the vehicles on the road of the first direction and the road of the second direction passing the crossing within the predefined period of time, weightJr denotes the weight of the jam level, and weightCt denotes the weight of the number of the vehicles passing the crossing.

15. An apparatus for controlling traffic lights of a crossing, a road of a first direction and a road of a second direction intersecting at the crossing, the apparatus comprising:
a computer, comprising:
a detecting unit configured to detect jam states of the road of the first direction and the road of the second direction for predefined regions in monitored images of the road of the first direction and the road of the second direction;
a counting unit configured to respectively count vehicles on the road of the first direction and the road of the second direction passing the crossing in the predefined regions within a predefined period of time; and
a controlling unit configured to control traffic lights of the road of the first direction and the road of the second direction based on the jam states of the road of the first direction and the road of the second direction and according to jam levels of the road of the first direction and the road of the second direction, weights assigned to the road of the first direction and the road of the second direction and a number of the vehicles on the road of the first direction and the road of the second direction passing the crossing within the predefined period of time.

16. A non-transitory computer readable storage storing a method, the method for controlling traffic lights of a crossing, a road of a first direction and a road of a second direction intersecting at the crossing, the method comprising:
detecting jam states of the road of the first direction and the road of the second direction for predefined regions in monitored images of the road of the first direction and the road of the second direction;
counting respectively vehicles on the road of the first direction and the road of the second direction passing the crossing in the predefined regions within a predefined period of time; and
controlling traffic lights of the road of the first direction and the road of the second direction based on the jam states of the road of the first direction and the road of the second direction and according to jam levels of the road of the first direction and the road of the second direction, weights of the road of the first direction and the road of the second direction and a number of the vehicles on the road of the first direction and the road of the second direction passing the crossing within the predefined period of time.
